(19) United States
(12) Patent Application Publication
(10) Pub. No.: US 2012/0308444 A1
(43) Pub. Date: Dec. 6, 2012

(54) Lateral Flow Immunoassay for Detecting Cardiac Troponin I and Myoglobin

(76) Inventor: Jimin Zhu, Shanghai (CN)

(21) Appl. No.: 13/483,049

(22) Filed: May 30, 2012

(30) Foreign Application Priority Data
May 30, 2011 (CN) 201110142274.0

(51) Int. Cl. G01N 21/78; B32B 37/14; B82Y 15/00

(52) U.S. Cl. 422/425; 156/306.6; 977/810

(57) ABSTRACT

In accordance with at least some embodiments of the present disclosure, a lateral flow immunoassay strip may include a first conjugate pad containing streptavidin-gold nanoparticle (streptavidin-AuNP) conjugates, a second conjugate pad containing anti-cardiac troponin I monoclonal antibody (anti-cTnI mAb)-AuNP-biotinylated single stranded DNA (ssDNA) conjugate complexes, and a nitrocellulose membrane coupled with the first conjugate pad and the second conjugate pad, wherein the nitrocellulose membrane contains a first test line prepared with capturing anti-cTnI mAb.

### CROSS-REFERENCE

This application claims priority to Chinese Patent Application No. 201110142274.0, filed on May 30, 2011, which is hereby incorporated by reference in it entirety, including any appendices or attachments thereof, for all purposes.

### BACKGROUND

Unless otherwise indicated herein, the approaches described in this section are not prior art to the claims in this application and are not admitted to be prior art by inclusion in this section.

Acute myocardial infarction (AMI) is considered to be the leading cause of morbidity and mortality worldwide. Early exclusion or diagnosis of AMI may allow efficient and cost-effective triage as well as the successful management of patients with AMI. Cardiac troponin I (cTnI), one of the cardiac muscle regulatory proteins located on the actin filament of normal cardiomyocyte, has a very low level (about 20.4 pg/mL) in the blood of healthy individuals. However, it starts to elevate rapidly within 2.2-6.8 hours after onset of AMI, and reaches the peak of 195.9 ng/mL after about 11.2 hours. Myoglobin (Myo), known as a preferable indicator for early marker of cardiomyocyte injury, has a baseline level of about 50 ng/mL in the blood of healthy subjects. The level of Myo increases significantly above the baseline level within 2-3 hours post infarct, peaks at 9-12 hours, and returns to the baseline level within 24-36 hours. Previous studies have suggested that a combined detection of cTnI and Myo may help facilitate a diagnosis of AMI within the first 90 minutes after presentation, compared with other cardiac markers, such as creatine kinase MB, cardiac troponin T, C-reactive protein and brain natriuretic peptide.

To date, a large number of approaches are available for detection of proteins presented in the circulation, such as radioimmunoassay, affinity chromatography, enzyme-linked immunosorbent assay and immunofluorescence. Although all these methods provide relatively specific and sensitive detection, these techniques also require sophisticated laboratory facilities, highly trained medical technologists, and time-consuming procedures. These challenges may hamper the adoption of proteins analysis in point-of-care settings.

### SUMMARY

Techniques described herein generally relate to the detecting a presence of an antigen. In one or more embodiments of the present disclosure, a lateral flow immunoassay strip contains a first conjugate pad having streptavidin-gold nanoparticle (streptavidin-AuNP) conjugates. The lateral flow immunoassay strip may contain a second conjugate pad having anti-cardiac troponin I monoclonal antibody (anti-cTnI mAb)-AuNP-biotinylated single stranded DNA (ssDNA) conjugate complexes. The lateral flow immunoassay strip may further contain a nitrocellulose membrane coupled with the first conjugate pad and the second conjugate pad, wherein the nitrocellulose membrane contains a first test line prepared with capturing anti-cTnI mAb.

upon receiving a sample by the first conjugate pad, the second conjugate pad, and the nitrocellulose membrane, the streptavidin-AuNP conjugates released by the first conjugate pad, the anti-cTn1 mAb-AuNP-biotinylated ssDNA conjugate complexes released by the second conjugate pad, and the capturing anti-cTn1 mAb immobilized on the first test line are configured to conjugate any cTnI in the sample at the first test line, allowing the first test line to indicate a presence of the cTnI in the sample.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 shows a diagrammatical illustration of a lateral flow immunoassay strip, according to one or more embodiments of the present disclosure;

FIG. 2 illustrates the chemical components on a lateral flow immunoassay strip, according to one or more embodiments of the present disclosure; and

FIG. 3 shows a diagrammatical illustration of the lateral flow immunoassay strip after assay, according to one or more embodiments of the present disclosure;

all arranged in accordance to at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated herein.

mom Throughout the disclosure, the term “LFIA” may refer to “lateral flow immunoassay.” The term “AuNP” may refer to “gold nanoparticle.” The term “cTnI” may refer to “cardiac troponin I.” The term “Myo” may refer to “myoglobin.” The term “anti-cTnI mAb” may refer to “anti-cTnI monoclonal antibody.” The term “ssDNA” may refer to “biotinylated single stranded DNA.” The term “anti-Myo mAb” may refer to “anti-Myo monoclonal antibody.” The term “PBS” may refer to “phosphate buffered saline.” The term “BSA” may refer to “bovine serum albumin.”

LFIA, known for its application to the commercially available pregnancy test, has the advantage of circumventing the inconveniences mentioned above. LFIA not only provides a means for performing the assay without the extensive handling of specimens, but also accelerates the analytical process to 15 minutes or less in most cases. Thus, numerous LFIAs have been developed and used in clinical medicine. Two main challenges that limit the practical application of LFIAs in point-of-care settings are: (a) limited applications of LFIA to multiple proteins at widely different concentrations, and (b) limited microgram-per-liter detection range.

During the past decade, the biotin-streptavidin amplification technique, known as a strong noncovalent biological interaction, has become a useful and versatile tool for application in immunology and related areas. In essence, the introduction of this tool coupled with immunolabelling technique (using AuNP, fluorescein, enzyme and isotope) results in a modified system having better specificity and sensitivity compared with its former format. The biotin-streptavidin system may be used in a variety of biological and medical disciplines for quantitative and qualitative detection of a trace amount of antigen, antibody, or receptor, and for localization of observation.

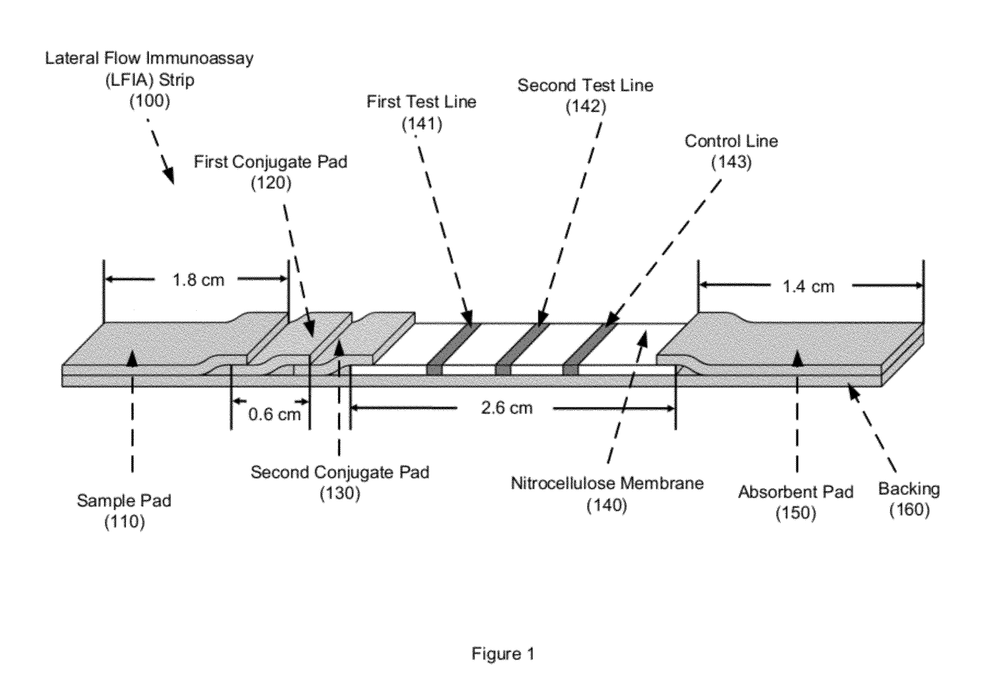

FIG. 1 shows a diagrammatical illustration of a LFIA strip according to one or more embodiments of the present disclosure. The LFIA 100 for simultaneous semi-quantitative determination of cTnI and Myo includes, without limitation, the following elements: a sample pad 110, a first conjugate pad 120, a second conjugate pad 130, a nitrocellulose membrane 140, an absorbent pad 150, and a backing 160. The nitrocellulose membrane 140 may have on its surface, without limitation, a first test line 141, a second test line 142, and a control line 143. The sample pad 110, the first conjugate pad 120, the second conjugate pad 130, and the absorbent pad 150 may be made from glass fibre or polyester fibre.

The first conjugate pad 120 may be pre-treated with streptavidin-AuNP conjugates. The second conjugate pad 130 may be pre-treated with (anti-cTnI mAb)-AuNP-ssDNA conjugate complexes (hereinafter “cTnI-detecting-complexes”). Further, the second conjugate pad 130 may contain (anti-Myo mAb)-AuNP conjugates.

The first test line 141 on the nitrocellulose membrane 140 may be pre-treated with “capturing (anti-cTnI mAb)”, which is an antibody that is similar to (anti-cTnI mAb) and for capturing a different epitope of cTnI. The second test line 142 on the nitrocellulose membrane 140 may be pre-treated with “capturing (anti-Myo mAb)”, which is an antibody that is similar to (anti-Myo mAb) and for capturing a different epitope of Myo. The control line 143 may be pre-treated with goat anti-mouse IgG.

In some embodiments, the sample pad 110 may have a length of about 1.8 cm. Each of the two conjugate pads 120 and 130 may have a length of about 0.6 cm. The nitrocellulose membrane 140 may have a length of about 2.6 cm. And the absorbent pad 150 may have a length of about 1.4 cm. The above components may then be assembled together on a plastic backing 160 with a 2 mm overlap in order to ensure continuous flow (by capillary action) of a sample solution from the sample pad 110 to the absorbent pad 150. After assembling, the result is a LFIA strip, with the sample pad 110 taking about 1.8 cm length of the strip, the conjugate pads 120 and 130 each taking about 0.4 cm length of the strip, the nitrocellulose membrane 140 taking about 2.2 cm length of the strip, and the absorption pad 150 taking up to 1.4 cm length of the strip.

The LFIA strip may be cut into 3 mm width using a cutter, sealed in a plastic bag in the presence of desiccant, and stored at room temperature for future use.

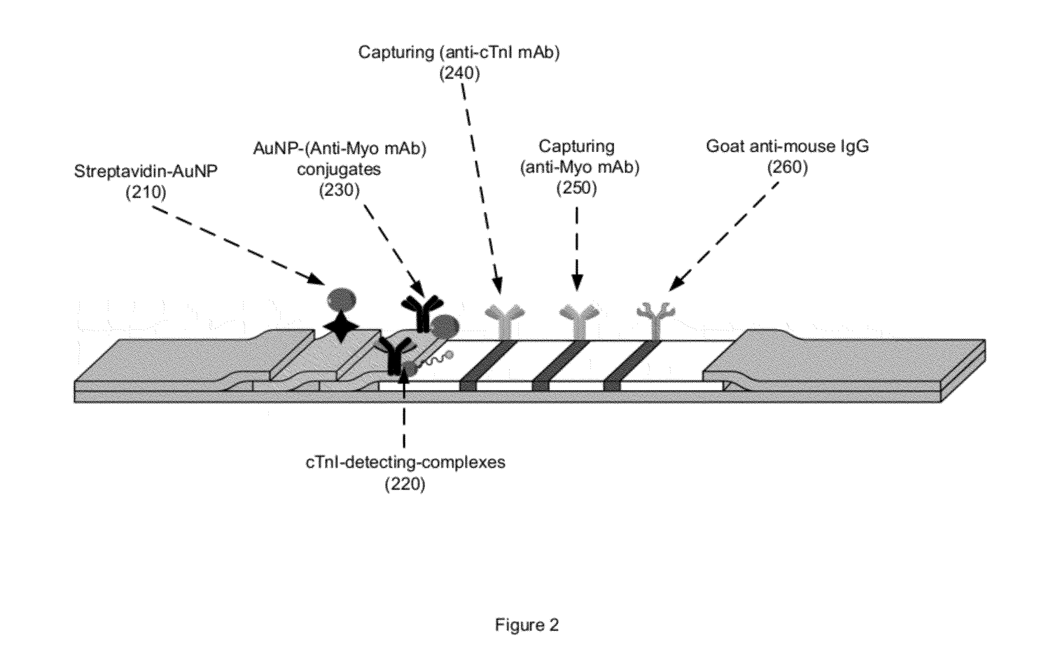

FIG. 2 illustrates the chemical components on a LFIA strip, according to one or more embodiments of the present disclosure.

In some embodiments, the sample pad 110 may be manufactured by saturating it with a first solution having a pH value at around 7.4. The first solution may contain about 10 mmol/L PBS, about 1% BSA (wt/vol), about 0.05% Tween-20 (vol/vol), and about 0.05% NaN₃ (wt/vol). The sample pad 110 may be placed in the first solution for about 30-60 minutes before drying in an air drier at around 37-45° C. for about 12-18 hours. Afterward, the sample pad 110 may be stored in a dry environment before being used for a LFIA strip.

In some embodiments, the sample pad 110 may be manufactured by saturating it with a second solution having a pH value at around 7.4. The second solution may contain about 20 mmol/L sodium borate, about 1% sucrose (wt/vol), about 1% BSA (wt/vol), about 0.5% Tween-20 (vol/vol), and about 0.05% NaN₃ (wt/vol). The sample pad 110 may be placed in the second solution for about 30-60 minutes before drying in an air drier at around 37-45° C. for about 12-18 hours. Afterward, the sample pad 110 may be stored in a dry environment before being used for a LFIA strip.

The first conjugate pad 120 and the second conjugate pad 130 may first be prepared by immersing them in a solution containing about 5% sucrose (wt/vol) and water for about 1 hour, and then be dried at about 37-45° C. for about 12-18 hours.

In some embodiments, the first conjugate pad 120 may contain streptavidin-AuNP conjugates 210, which may be formed by the following process using 41 nm diameter AuNP. The pH value of an AuNP (41 nm) solution may be adjusted drop-wise to about 9.0 with about 0.2 mol/L K₂CO₃. Afterward, a finishing solution of about 8 μg/mL of streptavidin may be added to the AuNP solution. The mixture may be incubated for about 30 minutes at room temperature (e.g., 10-40° C.), and followed by an addition of 10% BSA solution accounting for one-tenth of the total volume to block the residual surface of the AuNP. The obtained solution may then be centrifuged at about 12,000 rpm for about 30 minutes at approximately 4° C. Afterward, the supernatant may be discarded, leaving the precipitate that contains AuNP conjugate. And PBS (about 10 mmol/L with pH 7.4) containing about 1% BSA solution may be added to the AuNP conjugate, which may be resuspended. The above centrifugation and suspension process may be repeated twice, and the precipitate may then be resuspended in a Tris-HCl solution containing about 0.5% polyvinylpyrrolidone (wt/vol), about 1.25% sucrose (wt/vol), about 0.05% PEG8000 (wt/vol), about 0.2% BSA (wt/vol), and about 0.05% Tween-20 (vol/vol), and be stored at about 4° C. for future use.

In some embodiments, the second conjugate pad 130 may contain “cTnI-detecting-complexes” 220, which may be formed by the following process using 13 nm diameter AuNP. The pH value of an AuNP (13 nm) solution may be adjusted dropwise to about pH 8.5 with about 0.2 mol/L K₂CO₃. Afterward, 8 μL of a solution which contains (anti-cTnI mAb) having a concentration of 1 mg/mL may be added to the AuNP solution, forming a first solution. After about 30-minute incubation process at room temperature, the first solution, which contains AuNP with (anti-cTnI mAb), may be used to react with ssDNA (having a final concentration of about 1 μmol/L), resulting a second solution in about 16 hours. The PEG8000 (having a final concentration of about 0.5%) may be added to the second solution to stabilize the AuNP, resulting a third solution in about 15 minutes.

Further, a PBS (about 10 mmol/L with pH 7.4) may be added to the third solution, resulting a fourth solution having a concentration of 0.1 mol/L NaCl. The excess (anti-cTnI mAb) and ssDNA molecules may be removed from the fourth solution by centrifugation at about 9,000 rpm for about 50 minutes, at about 4° C. Afterward, the supernatant may be discarded from the fourth solution, and a Tris-HCl solution containing about 5% polyvinylpyrrolidone (wt/vol), about 1.25% sucrose (wt/vol), about 0.05% PEG8000 (wt/vol), about 0.2% BSA (wt/vol), and about 0.05% Tween-20 (vol/vol) may then be added to the fourth solution to form a fifth solution. The fifth solution may then be resuspended. The above centrifugation and suspension processes may be repeated twice. In the end, the precipitate from the above process may be suspended in the Tris-HCl solution containing about 0.5% polyvinylpyrrolidone (wt/vol), about 1.25% sucrose (wt/vol), about 0.05% PEG8000 (wt/vol), about 0.2% BSA (wt/vol), and about 0.05% Tween-20 (vol/vol), and be stored at about 4° C. for future use.

In some embodiments, the second conjugate pad 130 may contain AuNP-(anti-Myo mAb) conjugates 230, which may be formed by the following process using 13 nm diameter AuNP. The pH value of an AuNP (13 nm) solution may be adjusted dropwise to 8.5 with 0.2 mol/L K₂CO₃. Afterward, 8 μL of anti-Myo mAb (having a concentration of about 1 mg/mL) may be added to the AuNP solution. After a 30-minute incubation process at room temperature, the AuNP with (anti-Myo mAb) solution may be used to react with a BSA solution (having 10% of BSA, and accounting for one-tenth of the total volume) to block the residual surface of the AuNP. The obtained solution may be centrifuged at about 12,000 rpm for about 30 minutes at about 4° C. Afterward, the supernatant may be discarded and PBS (about 10 mmol/L with pH 7.4) containing 1% BSA solution may be added to the precipitate, which may then be resuspended. The above centrifugation and suspension process may be repeated twice, with the finishing precipitate resuspended in a Tris-HCl solution containing about 0.5% polyvinylpyrrolidone (wt/vol), about 1.25% sucrose (wt/vol), about 0.05% PEG8000 (wt/vol), about 0.2% BSA (wt/vol), and about 0.05% Tween-20 (vol/vol), and be stored at about 4° C. for future use.

In some embodiments, the cTnI-detecting-complexes may be mixed with the AuNP-(anti-Myo mAb) complex in a 1:1 ratio, forming a “second conjugate pad complexes.” Afterward, 2 μL/strip of streptavidin-AuNP complex may be applied onto a polyester fiber as the first conjugate pad 120, and 3 μL/strip of the second conjugate pad complexes may be applied onto a polyester fiber to be used as the second conjugate pad 130. The first conjugate pad 120 and the second conjugate pad 130 may be dried for about 12 hours at about 37° C., and stored in a dry state for future use.

In some embodiments, the capturing (anti-cTnI mAb) 240 for the first test line 141, the capturing (anti-Myo mAb) 250 for the second test line 142, and the (goat anti-mouse IgG) 260 for the control line 143, may each be in a corresponding solution having about 1 mg/mL concentration. Each of the above solutions may be applied onto the nitrocellulose membrane 140 by a dispenser system. The nitrocellulose membrane 140 may then be dried in an air drier at about 37-45° C. for about 12-18 hours, and stored in a dry state for future use.

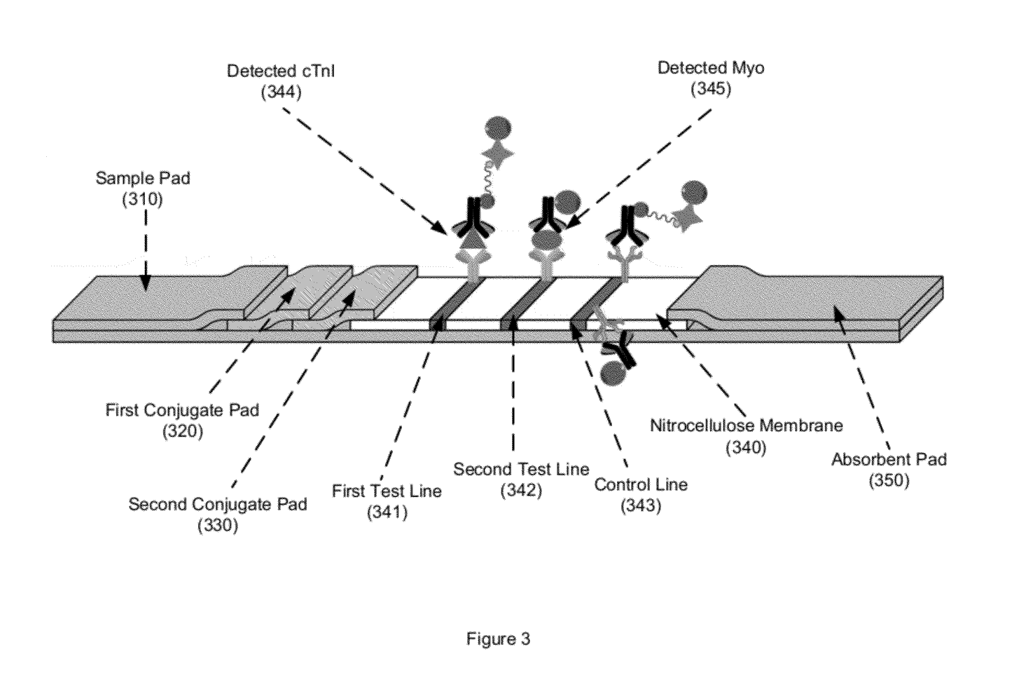

FIG. 3 shows a diagrammatical illustration of the LFIA strip after assay according to one or more embodiments of the present disclosure.

In some embodiments, a sample solution (which may or may not contain cTnI and/or Myo) may be introduced onto the sample pad 310. Within a short period (e.g., 1-5 minutes), the sample solution may migrate toward the first conjugate pad 320 via capillary action and rehydrate the streptavidin-AuNP conjugates on the first conjugate pad 320. After another short period (e.g., 1-5 minutes), the sample solution may migrate toward the second conjugate pad 330 and rehydrate the cTnI-detecting-complexes and the AuNP-(anti-Myo mAb) conjugates on the second conjugate pad 330. If the sample solution contains cTnI, then the cTnI may bind with the cTnI-detecting-complexes and form a first cTnI-complexes. Likewise, if the sample solution contains Myo, then the Myo may bind with AuNP-(anti-Myo mAb) conjugates and form a first Myo-complexes.

In some embodiments, when the first cTnI-complexes reached the first test line 341, they may be captured by the capturing (anti-cTnI mAb) embedded in the first test line 341, resulting in a second cTnI-complexes. The interactions between the first cTnI-complexes and the capturing (anti-cTnI mAb) may result in the detecting of the cTnI in the sample solution. Meanwhile, the streptavidin-AuNP from the first conjugate pad 320 may continue to migrate along the LFIA strip at a relatively slower speed because of the streptavidin-AuNP particles' relative larger mass comparing to the first cTnI-complexes. When the streptavidin-AuNP reaches the first test line 341, the binding between the second cTnI-complexes and streptavidin-coated AuNP (41 nm) may occur, as the biotin may interact with the streptavidin to form a strong connection. Thus, a characteristic red band may be observed at the first test line 341, indicating a presence of the cTnI in the sample solution.

In some embodiments, when the first Myo-complexes reach the second test line 342, they may be captured by the capturing (anti-Myo mAb) embedded in the second test line 342, resulting in a second Myo-complexes. The interaction between the first Myo-complexes and the capturing (anti-Myo mAb) may result in the detecting of the Myo in the sample solution. Thus, a characteristic red band may be observed at the second test line 342, indicating a presence of the Myo in the sample solution.

In some embodiments, the capillary action may cause the sample solution to migrate further and toward the absorbent pad 350. Once the sample solution passes through the control line 343, the excess conjugates (including cTnI-detecting-complexes and the AuNP-(anti-Myo mAb) conjugates that are not captured at the first test line 341 and/or the second test line 342 may be captured at the control line 343 by the (goat anti-mouse IgG), producing a red color at the control line 343.

In some embodiments, the above LFIA strip may be packages as a test cassette and sealed in a pouch. To test a sample solution, the pouch may be opened in room temperature, the test cassette may be removed from the sealed pouch, and the LFIA strip may be used as soon as possible. Best results may be obtained if the test is performed soon after opening the foil pouch.

In some embodiments, the test cassette may be placed on a clean and leveled surface, and about 150 μL of a standard solution or a sample solution extracted by the test device may be dispensed on the sample pad of the LFIA strip. The results (red lines appearing) should be read at about 15 minutes. After 20 minutes, the results may no longer be reliable or conclusive.

In some embodiments, the test result may be positive when both the first test line 341 and the second test line 342 show a color (e.g., red) within their respective test line regions. The intensity of the color in the test line region(s) may vary depending on the concentration of cTnI and/or Myo in the sample solution. Further, any shade of color in the test line regions may be considered positive.

The test result may be negative if either the first test line 341 or the second test line 342, but not both, shows a color, or none of the first test line 341 and the second test line 342 shows any color. This indicates that the concentration of Myo and cTnI may be below the minimum detection level (e.g., below 1 pg/mL).

The test result may be invalid when the control line 343 fails to show any color. This may be caused by insufficient specimen volume or incorrect procedural techniques. The procedure and the test may be repeated.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claim

What is claimed is:

1. A lateral flow immunoassay (LFIA) strip, comprising:
a first conjugate pad containing streptavidin-gold nanoparticle (streptavidin-AuNP) conjugates;
a second conjugate pad containing anti-cardiac troponin I monoclonal antibody (anti-cTnI mAb)-AuNP-biotinylated single stranded DNA (ssDNA) conjugate complexes; and
a nitrocellulose membrane coupled with the first conjugate pad and the second conjugate pad, wherein the nitrocellulose membrane contains a first test line prepared with capturing (anti-cTnI mAb), and
upon receiving a sample by the first conjugate pad, the second conjugate pad, and the nitrocellulose membrane, the streptavidin-AuNP conjugates released by the first conjugate pad, the (anti-cTn1 mAb)-AuNP-biotinylated ssDNA conjugate complexes released by the second conjugate pad, and the capturing (anti-cTn1 mAb) immobilized on the first test line are configured to conjugate any cTnI in the sample at the first test line, allowing the first test line to indicate a presence of the cTnI in the sample.

2. The LFIA strip as recited in claim 1, further comprising
a sample pad for initially receiving and pre-treating the sample, wherein the sample pad is positioned closer to the first conjugate pad than to the second conjugate pad or the nitrocellulose membrane.

3. The LFIA strip as recited in claim 1, wherein the nitrocellulose membrane further contains a control line pretreated with goat anti-mouse IgG for indicating a proper performance of the LFIA strip.

4. The LFIA strip as recited in claim 1, wherein the second conjugate pad is positioned closer to the nitrocellulose membrane than the first conjugate pad, allowing the (anti-cTnI mAb)-AuNP-biotinylated ssDNA conjugate complexes from the second conjugate pad to reach the first test line before the streptavidin-AuNP conjugates from the first conjugate pad.

5. The LFIA strip as recited in claim 1, further comprising
an absorbent pad for absorbing an excessive amount of the sample, wherein an absorbent pad is positioned closer to the nitrocellulose membrane than to the first conjugate pad or the second conjugate pad.

6. The LFIA strip as recited in claim 1, wherein the second conjugate pad further contains AuNP-anti-myoglobin monoclonal antibody (anti-Myo mAb) conjugates, and the nitrocellulose membrane further contains a second test line prepared with capturing (anti-Myo mAb), allowing the second test line to indicate a presence of the Myo in the sample.

7. A lateral flow immunoassay (LFIA) strip, comprising:
a first conjugate pad containing streptavidin-gold nanoparticle (streptavidin-AuNP) conjugates;
a second conjugate pad containing AuNP-anti-myoglobin monoclonal antibody (anti-Myo mAb) conjugates and anti-cardiac troponin I antibody (anti-cTnI mAb)-AuNP-biotinylated-single stranded DNA (ssDNA) conjugate complexes; and
a nitrocellulose membrane coupled with the first conjugate pad and the second conjugate pad, wherein the nitrocellulose membrane contains a first test line, a second test line, and a control line, the first test line is prepared with capturing (anti-cTnI mAb), the second test line is prepared with capturing (anti-Myo mAb), and the control line is prepared with goat anti-mouse IgG.

8. The LFIA strip as recited in claim 7, wherein the AuNP-(anti-Myo mAb) conjugates and the (anti-cTnI mAb)-AuNP-biotinylated ssDNA conjugate complexes have a 1:1 concentration ratio on the second conjugate pad.

9. The LFIA strip as recited in claim 7, wherein the first test line, the second test line, and the control line are formed using 1 mg/mL of the capturing (anti-Myo mAb), the capturing (anti-cTnI mAb), and the goat anti-mouse IgG, respectively.

10. The LFIA strip as recited in claim 7, further comprising
a sample pad and an absorbent pad, wherein the sample pad is coupled with the first conjugate pad, the first conjugate pad is coupled with the second conjugate pad, the second conjugate pad is coupled with the nitrocellulose membrane, and the nitrocellulose membrane is coupled with the absorbent pad.

11. The LFIA strip as recited in claim 7, wherein the nitrocellulose membrane has the first test line, the second test line, and the control line positioned in an evenly order.

12. A method to build a lateral flow immunoassay (LFIA) strip, comprising:
preparing a first conjugate pad with a first solution containing streptavidin-gold nanoparticle (AuNP) conjugates;
preparing a second conjugate pad containing AuNP-anti-myoglobin monoclonal antibody (anti-Myo mAb) conjugates and anti-cardiac troponin I antibody (anti-cTnI mAb)-AuNP-biotinylated single stranded DNA (ssDNA) conjugate complexes
preparing a nitrocellulose membrane by spread-painting a first test line and a second test line on a surface of the nitrocellulose membrane, wherein the first test line is prepared with capturing (anti-cTnI mAb), and the second test line is prepared with capturing (anti-Myo mAb); and
constructing the LFIA strip by assembling together the first conjugate pad, the second conjugate pad, and the nitrocellulose membrane.

13. The method as recited in claim 12, wherein the AuNPs in the streptavidin-AuNP conjugates have a diameter size of about 41 nm.

14. The method as recited in claim 12, wherein AuNPs in the AuNP-(anti-Myo mAb) conjugates have a size of about 13 nm in diameter, and AuNPs in the (anti-cTnI mAb)-AuNP-biotinylated ssDNA conjugate complexes have a diameter size of 13 nm.

15. The method as recited in claim 12, wherein the first conjugate pad and the second conjugate pad are pretreated in a purified water solution containing 5% sucrose (wt/vol).

16. The method as recited in claim 12, wherein the sample pad is saturated with a solution containing about 1% bovine serum albumin (wt/vol), about 0.05% Tween-20 (vol/vol), and about 0.05% NaN₃ (wt/vol).

17. The method as recited in claim 12, wherein the streptavidin-AuNP conjugates are prepared by adding AuNP with streptavidin, and stored in a solution.

18. The method as recited in claim 12, wherein the AuNP-(anti-Myo mAb) conjugates are prepared by adding AuNP with anti-Myo mAb, and stored in a solution.

19. The method as recited in claim 12, wherein the (anti-cTnI mAb)-AuNP-biotinylated ssDNA conjugate complexes are prepared by adding AuNP with (anti-cTnI mAb) and biotinylated ssDNA, and stored in a solution.

20. The method as recited in claim 12, wherein a precipitate solution for the streptavidin-AuNP conjugates, the AuNP-(anti-Myo mAb) conjugates, and the (anti-cTnI mAb)-AuNP-biotinylated ssDNA conjugate complexes contain a Tris-HCl solution, which contains about 0.5% polyvinylpyrrolidone (wt/vol), about 1.25% sucrose (wt/vol), about 0.05% PEG8000 (wt/vol), about 0.2% BSA (wt/vol), and about 0.05% Tween-20 (vol/vol).
